(19) United States
(12) Patent Application Publication
(10) Pub. No.: US 2025/0272544 A1
(43) Pub. Date: Aug. 28, 2025

(54) GENERATING AND EXECUTING ACTION PLANS INVOLVING SOFTWARE TOOLS VIA A LARGE LANGUAGE MODEL

(71) Applicant: Adobe Inc., San Jose, CA (US)

(72) Inventors: Yuchen Zhuang, Atlanta, GA (US); Xiang Chen, Palo Alto, CA (US); Victor Soares Bursztyn, Mountain View, CA (US); Tong Yu, San Jose, CA (US); Somdeb Sarkhel, San Jose, CA (US); Saayan Mitra, San Jose, CA (US); Ryan A Rossi, Santa Clara, CA (US)

(21) Appl. No.: 18/589,065

(22) Filed: Feb. 27, 2024

(51) Int. Cl. G06N 3/0455

(52) U.S. Cl. CPC G06N 3/0455

(57) ABSTRACT

Methods, systems, and non-transitory computer readable storage media are disclosed for generating action plans utilizing a large language model with a best-first search model. The disclosed system determines a request to utilize a large language model to generate an action plan via one or more software tools. The disclosed system generates the action plan by traversing a decision tree comprising an action space involving the one or more software tools by iteratively: selecting, utilizing a best-first search model, an action from a set of possible actions in the action space of the decision tree; and expanding, utilizing the best-first search model, the action space of the decision tree to include an additional set of possible actions. The disclosed system also executes the action plan via one or more interactions with the one or more software tools according to the action.

### BACKGROUND

Improvements to machine-learning and neural network based computer processing technologies have led to significant advancements in many different computing environments. Specifically, the increasing capabilities and prevalence of large language models have increased the ability for many entities to utilize machine-learning to implement and streamline various computing operations. For example, computing agents involving large language models can interact with software tools (e.g., via functional application programming interfaces (“APIs”)) to identify specific actions to execute in a series of API calls (or other software tool interactions), often in a step-by-step manner. The variety of possible API calls, however, results in large action spaces and more difficult navigation through the action space. Accurate and efficient navigation through such an action space is a critical aspect of action planning for entities to ensure that the entities have sufficient computing resources to perform the various computing operations.

Although some conventional computing systems provide decision-making or planning for computing systems, such systems have a number of problems related to flexibility and efficiency. For instance, some conventional systems generate action plans by rigidly exploring expansive action spaces in a single direction. Such conventional systems often cause error propagation originating from a mistaken action and leading to a faulty exploration loop in the action space. These conventional systems are also limited in their exploration capabilities, resulting in exploring only a small portion of a given large action space, which can result in the action plans being locked into locally optimal solutions without exploring globally optimal solutions. To illustrate, computing systems that utilize such conventional systems to perform API calls to various software tools can result in executing incorrect operations and/or interacting with the wrong software tools as a result of limited exploration.

Some conventional systems attempt to overcome the limitations of unidirectional systems by utilizing tree search-based models. In particular, the conventional systems that use tree search-based models explore all (or most) possible actions in a decision space to reach more globally optimized decisions. Such conventional models that utilize exhaustive searches in the action spaces often require significant amounts of time and processing/communication resources-both to perform the search and to interact with software tools in connection with executing certain actions for intermediate reasoning steps. Thus, these conventional systems are inefficient and not practical for many entities with limited resources and/or limited time.

### SUMMARY

One or more embodiments provide benefits and/or solve one or more of the foregoing or other problems in the art with systems, methods, and non-transitory computer readable storage media for generating and executing action plans involving various software tools utilizing a large language model. In response to a request to utilize a large language model to generate an action plan involving software tools, the disclosed systems generate the action plan by traversing a decision tree including an action space. Specifically, the disclosed systems utilize a best-first search model to iteratively select actions from the action space (e.g., corresponding to nodes in the decision tree), expand the action space, and update value functions for the actions. For example, the disclosed systems select an action from a set of possible actions according to a combination of a cumulative cost score and a future cost score of the action. Additionally, the disclosed systems expand the action space to include additional possible actions descending from the selected action and generate corresponding scores for the additional possible actions. The disclosed systems thus generate an efficient and accurate action plan by continuing to explore the action space to select actions that result in a lowest cost for the action plan. In some embodiments, the disclosed systems also execute the action plan by interacting with one or more software tools according to the selected actions in the action plan.

### BRIEF DESCRIPTION OF THE DRAWINGS

Various embodiments will be described and explained with additional specificity and detail through the use of the accompanying drawings.

FIG. 1 illustrates an example system environment in which a software action planning system operates in accordance with one or more implementations.

FIG. 2 illustrates a diagram of an overview of the software action planning system generating and executing an action plan using an large language model in accordance with one or more implementations.

FIG. 3 illustrates a diagram of the software action planning system exploring actions in an action space to generate an action plan in accordance with one or more implementations.

FIG. 4 illustrates a diagram of the software action planning system generating cost scores for selecting an action from a set of possible actions in accordance with one or more implementations.

FIG. 5 illustrates a diagram of the software action planning system generating a cumulative cost score for an action utilizing a large language model in accordance with one or more implementations.

FIG. 6 illustrates a diagram of the software action planning system generating a future cost score for an action utilizing a large language model in accordance with one or more implementations.

FIG. 7 illustrates a diagram of the software action planning system executing an action plan by performing API calls to software tools in accordance with one or more implementations.

FIGS. 8A-8C illustrate graphical user interfaces for generating an action plan utilizing a large language model in accordance with one or more implementations.

FIG. 9 illustrates a diagram of an example implementation of the software action planning system generating an action plan in an action space as compared to a conventional system in accordance with one or more implementations.

FIG. 10 illustrates a diagram of an example of the software action planning system in accordance with one or more embodiments.

FIG. 11 illustrates a flowchart of a series of acts for utilizing a large language model with a best-first search model to generate an action plan involving one or more software tools in accordance with one or more implementations.

FIG. 12 illustrates a block diagram of an exemplary computing device in accordance with one or more embodiments.

### DETAILED DESCRIPTION

One or more embodiments of the present disclosure include an software action planning system that utilizes a large language model with a best-first search model to generate an action plan. For example, the software action planning system utilizes the large language model in the best-first search model (e.g., an A* search model) to iteratively select actions from an action space and expand the action space while exploring the action space in a decision tree. Specifically, the software action planning system generates the action plan by iteratively utilizing cost scores to select actions in the action space, expands the action space based on the selected actions, and updates cost scores for additional possible actions in the action space. For example, the software action planning system utilizes the best-first search model to generate cumulative cost scores and future cost scores for possible actions based on previously selected actions and possible future actions in the action space. In some embodiments, the software action planning system also executes the action plan by executing one or more calls to one or more software tools according to the actions in the action plan.

As mentioned, in one or more embodiments, the software action planning system generates an action plan in response to a request to generate the action plan involving software tools. In particular, the software action planning system leverages a large language model to traverse a decision tree including an action space involving the software tools. For example, the software action planning system provides exploration of the action space in the decision tree by utilizing the large language model to interact with the software tools at various steps of the exploration process and determine costs associated with the various actions. More specifically, the software action planning system utilizes a best-first search model to iteratively select actions in the action space, expand the action space, and update cost scores of possible actions to navigate nodes in the decision tree.

In one or more embodiments, the software action planning system utilizes a best-first search model to explore the action space of the decision tree. For instance, the software action planning system generates cumulative cost scores for possible actions based on a self-consistency of the large language model and heuristics of successful action plan examples stored in a long-term memory of the large language model. Additionally, the software action planning system generates future cost scores for future possible actions based on heuristics of actions in the successful plan examples stored in the long-term memory of the large language model and an imagined/predicted action plan generated by the large language model. The software action planning system combines the cumulative cost score and the future cost score to determine combined costs of actions in a set of possible actions and selects the action with the lowest cost value.

In additional embodiments, in response to selecting an action, the software action planning system expands the action space based on the selected action. Specifically, the software action planning system determines an additional set of possible actions linked to the selected action. Additionally, the software action planning system updates cost scores of the expanded action space by determining cumulative cost scores and future cost scores for the additional set of possible actions and continues exploring the action space based on the updated cost scores. Furthermore, in some embodiments, the software action planning system executes the action plan by interacting with the software tools (e.g., via one or more API calls to the software tools) according to the actions and action sequence indicated in the action plan. In additional embodiments, the software action planning system also utilizes the large language model to execute the action plan.

The software action planning system provides a number of advantages in computing systems that implement action planning utilizing software tools. For example the software action planning system improves accuracy by utilizing a best-first, tree search-based model to generate an action plan involving interactions with software tools. In contrast to conventional systems that utilize unidirectional search models to generate action plans, the software action planning system provides globally accurate and optimized action plans by exploring greater numbers of actions within an action space with a tree search-based model. In particular, the software action planning system utilizes a best-first search model (e.g., an A* search model) to explore nodes of a decision tree and identify an action plan that most accurately fulfils a request for the action plan. To illustrate, the software action planning system utilizes the best-first search model with a large language model to explore a higher number of possible actions than the unidirectional systems of the conventional systems.

Furthermore, the software action planning system improves the efficiency of computing systems generating action plans by utilizing a best-first search model to explore an action space. In contrast to conventional systems that utilize tree search-based models to explore an action space, the software action planning system provides similar accuracy in generated action plans while greatly reducing the amount of time and resources to explore the action space. For instance, while conventional systems utilize inefficient tree search-based methods such as Monte Carlo tree search methods, the software action planning system utilizes a best-first search model (e.g., an A* search model) to perform one-step expansion of an action space guided by cost functions for the actions. By using the best-first search model to explore the action space, the software action planning system significantly reduces search time and action plan costs over the conventional systems while still providing highly accurate action plans.

Additionally, because the software action planning system reduces the search time and action plan costs by using the best-first search model, the software action planning system also reduces the computing resources required to generate and execute the action plan. In particular, action planning involving software tools can include various intermediate steps that involve a large language model interacting with software tools via various calls to the large language model and/or API calls to the software tools. In contrast to conventional tree search-based systems that can involve performing a plurality of calls to the large language model for expanding an action space, the software action planning system utilizes a single large language model call for determining the next possible actions during expansion. More specifically, the software action planning system utilizes a plurality of cost functions (e.g., to generate cumulative cost scores and future cost scores) to select actions and expand an action space via the large language model, which limits the number of times a computing system issues a call to the large language model. Thus, the software action planning system also reduces the number of computing resources required to efficiently explore an action space while also providing high accuracy relative to other tree search-based models.

As used herein, the term “large language model” refers to an artificial intelligence model capable of processing and generating natural language text or other language-based prompts using language understanding. In particular, large language models are trained on large amounts of data to learn patterns and rules of language. As such, a large language model post-training is capable of generating output predictions that indicate visualization structures. Further, in some embodiments, a large language model includes or refers to one or more transformer-based neural networks capable of processing language-based prompts (e.g., natural language text) to generate outputs that range from predictive outputs, analyses, or combinations of data within stored content items. In particular, a large language model includes parameters trained (e.g., via deep learning) on large amounts of data to learn patterns and rules of language for summarizing and/or generating digital content. In one or more embodiments, the software action planning system utilizes a large language model as described by Jivat Neet Kaur, Sumit Bhatia, Milan Aggarwal, Rachit Bansal, and Balaji Krishnamurthy in “LM-CORE: Language Models with Contextually Relevant External Knowledge” in arXiv:2208.06458v1, 2022, which is herein incorporated by reference in its entirety.

As used herein, the term “action plan” refers to a set of steps or tasks to complete a goal in a computing environment. In some embodiments, an action plan includes a plurality of ordered steps involving various processes by a computing system to achieve a target. Additionally, as used herein, the term “action” refers to a specific computing operation. For example, an action involves one or more computing devices executing instructions to perform an operation at the one or more computing devices or to communicate with one or more additional computing devices. Furthermore, as used herein, the term “action space” refers to a set of all valid actions or choices available to a processing agent in a computing environment.

As used herein, the term “software tool” refers to a tool that performs one or more operations by executing computing instructions. In some embodiments, a software tool includes a software application, an application programming interface, a software library, or other set of functions for executing computing operations in a computing environment.

As used herein, the term “best-first search model” refers to an informed computing model that searches an action space using weighted graphs. Specifically, a best-first search model causes a computing system to search an action space by traversing nodes in a decision tree according to costs of the nodes. As an example, a best-first search model includes an A* search model that determines costs of the nodes in terms of cumulative cost scores and future cost scores of the nodes. Accordingly, the best-first search model explores the action space by identifying nodes resulting in the lowest cost scores to achieve a target.

As used herein, the term “cumulative cost score” refers to a value representing a cost of a particular action in an action space. For example, the cumulative cost score represents single-step costs of an action according to its ancestor nodes based on a self-consistency score of a large language model and a heuristic plan score of a long-term memory of the large language model. As used herein, the term “self-consistency score” refers to a value representing a consistency of a large language model in generating responses to prompt inputs. As used herein, the term “heuristic plan score” refers to a value representing a heuristic of successful action plan examples stored in long-term memory for the large language model.

As used herein, the term “future cost score” refers to a value representing a cost of a set of possible actions branching from a current action. In particular, the future cost score represents rewards for a possible action based on an imagination score of the large language model and a heuristic action score of a long-term memory of the large language model. As used herein, the term “imagination score” refers to a value representing a similarity of a current action plan to a predicted action plan generated by the large language model. As used herein, the term “heuristic action plan” refers to a value representing a heuristic of action positions in successful action plan examples stored in long-term memory for the large language model.

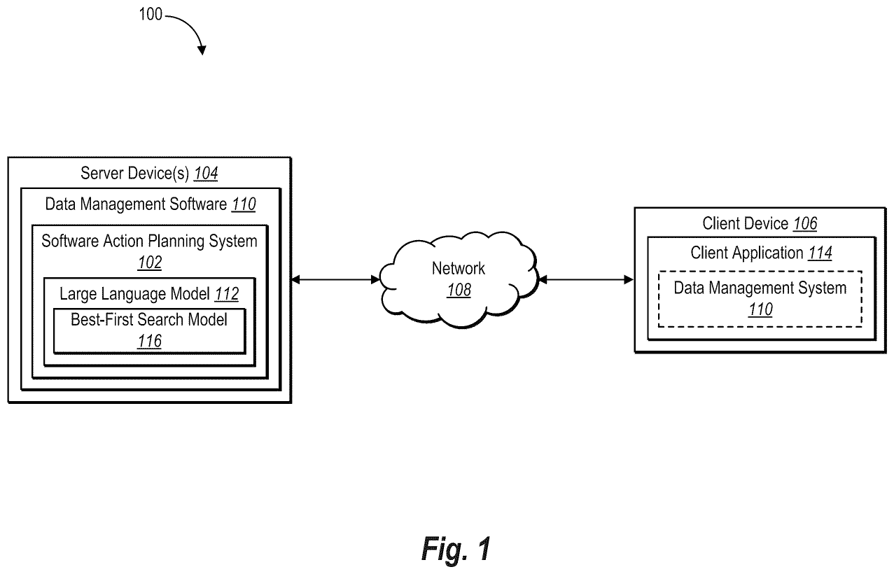

Turning now to the figures, FIG. 1 includes an embodiment of a system environment 100 in which a software action planning system 102 is implemented. In particular, the system environment 100 includes server device(s) 104 and a client device 106 in communication via a network 108. Moreover, as shown, the server device(s) 104 include a data management system 110, which includes the software action planning system 102. Additionally, the software action planning system 102 includes, or accesses, a large language model 112. Although FIG. 1 illustrates that the server device(s) 104 host the large language model 112, in alternative embodiments, the large language model 112 is hosted by another device or system (e.g., a third-party computing system). Furthermore, the client device 106 includes a client application 114, which optionally includes the data management system 110 and the software action planning system 102.

As shown in FIG. 1, the client device 106 or the server device(s) 104 include or host the data management system 110. The data management system 110 includes, or is part of, one or more systems that implement digital data management operations. For example, the data management system 110 provides tools for managing digital data associated with data tracking campaigns (e.g., in connection with digital marketing campaigns). To illustrate, the data management system 110 communicates with the client device 106 via the network 108 to provide the tools for display and interaction via the client application 114 at the client device 106. Additionally, in some embodiments, the data management system 110 receives requests to access digital data stored (e.g., at the server device(s) 104 or at another device such as a database) and/or requests to store digital data. In some embodiments, the data management system 110 receives interaction data for viewing or performing various processing operations on data associated with a digital tracking campaign and provides the results of the interaction data for display via the client application 114 or to a third-party system.

According to one or more embodiments, the data management system 110 utilizes the software action planning system 102 to generate action plans for achieving various targets in a computing environment. In particular, the data management system 110 utilizes the software action planning system 102 to explore an action space of possible actions to interact with various software tools and determine a sequence of actions involving the software tools to achieve a target. For example, as illustrated in more detail below, the software action planning system 102 utilizes the large language model 112 to generate an action plan including one or more intermediate steps involving interactions with software tools. Furthermore, the software action planning system 102 utilizes a best-first search model 116 (e.g., an A* search model) with the large language model 112 to efficiently generate action plans that accurately achieve a target. Additionally, the software action planning system 102 provides tools (e.g., via the client application 114) for executing a generated action plan. In some implementations, the software action planning system 102 provides tools for executing an action plan by causing the large language model 112 to interact with software tools.

As illustrated in FIG. 1, the software action planning system 102 can be implemented on the client device 106 or on the server device(s) 104. In particular, in some implementations, the software action planning system 102 on the server device(s) 104 supports the software action planning system 102 on the client device 106. For instance, the server device(s) 104 generates or obtains the software action planning system 102 for the client device 106 (e.g., as part of a software application or suite). The server device(s) 104 provides the software action planning system 102 to the client device 106 for performing digital image editing or analysis processes at the client device 106. In other words, the client device 106 obtains (e.g., downloads) the software action planning system 102 from the server device(s) 104. At this point, the client device 106 is able to utilize the software action planning system 102 to generate action plans independently from the server device(s) 104.

In additional embodiments, although FIG. 1 illustrates the server device(s) 104 and the client device 106 communicating via the network 108, the various components of the system environment 100 communicate and/or interact via other methods (e.g., the server device(s) 104 and the client device 106 communicate directly). Furthermore, although FIG. 1 illustrates the software action planning system 102 being implemented by a particular component and/or device within the system environment 100, the software action planning system 102 is implemented, in whole or in part, by other computing devices and/or components in the system environment 100. For example, in some embodiments, the server device(s) 104 include or host the data management system 110 and/or the software action planning system 102.

To illustrate, the software action planning system 102 includes a web hosting application that allows the client device 106 to interact with content and services hosted on the server device(s) 104 (e.g., in a software as a service implementation). To illustrate, in one or more implementations, the client device 106 accesses a web page supported by the server device(s) 104. The client device 106 provides input to the server device(s) 104 to perform intelligent action planning and, in response, the software action planning system 102 or the data management system 110 on the server device(s) 104 performs operations to generate an action plan via the large language model 112. The server device(s) 104 provide the output or results of the operations to the client device 106.

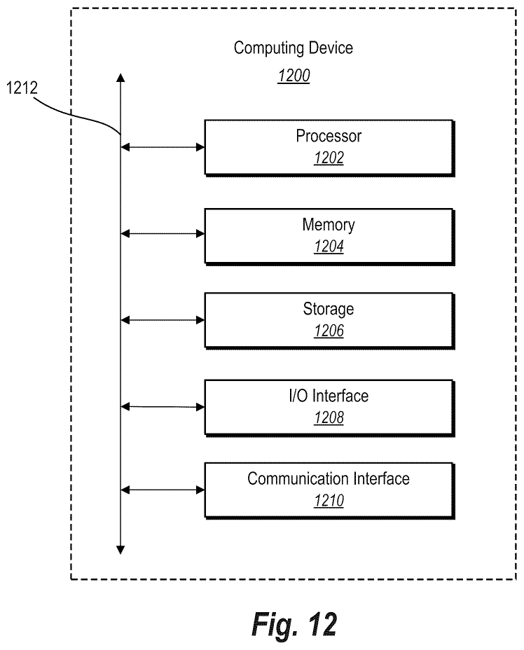

In one or more embodiments, the server device(s) 104 include a variety of computing devices, including those described below with reference to FIG. 12. For example, the server device(s) 104 includes one or more servers for storing and processing data associated with action planning. In some embodiments, the server device(s) 104 also include a plurality of computing devices in communication with each other, such as in a distributed storage environment. In some embodiments, the server device(s) 104 include a content server. The server device(s) 104 also optionally includes an application server, a communication server, a web-hosting server, a social networking server, a digital content campaign server, or a digital communication management server.

In addition, as shown in FIG. 1, the system environment 100 includes the client device 106. In one or more embodiments, the client device 106 includes, but is not limited to, a mobile device (e.g., smartphone or tablet), a laptop, a desktop, including those explained below with reference to FIG. 12). Furthermore, although not shown in FIG. 1, the client device 106 is operable by a user (e.g., a user included in, or associated with, the system environment 100) to perform a variety of functions. In particular, the client device 106 performs functions such as, but not limited to, accessing, viewing, generating and executing action plans. In some embodiments, the client device 106 also performs functions for generating, capturing, or accessing data to provide to the data management system 110 and the software action planning system 102 in connection with action planning and execution. For example, the client device 106 communicates with the server device(s) 104 via the network 108 to provide information (e.g., user interactions) associated with action plans. Although FIG. 1 illustrates the system environment 100 with a single client device, in some embodiments, the system environment 100 includes a different number of client devices.

Additionally, as shown in FIG. 1, the system environment 100 includes the network 108. The network 108 enables communication between components of the system environment 100. In one or more embodiments, the network 108 may include the Internet or World Wide Web. Additionally, the network 108 optionally include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server device(s) 104 and the client device 106 communicates via the network using one or more communication platforms and technologies suitable for transporting data and/or communication signals, including any known communication technologies, devices, media, and protocols supportive of data communications, examples of which are described with reference to FIG. 12.

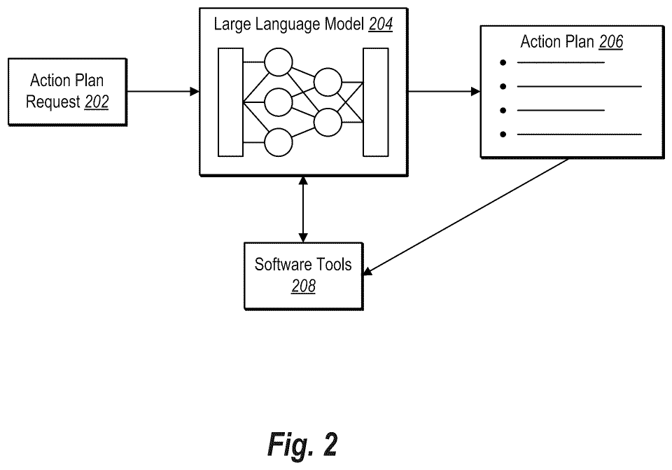

As mentioned, the software action planning system 102 utilizes a best-first search model with a large language model to generate action plans in computing environments. FIG. 2 illustrates the software action planning system 102 utilizing a large language model to generate an execute an action plan to achieve a target within a computing environment. Specifically, FIG. 2 illustrates that the software action planning system 102 utilizes the large language model to generate and, in some embodiments, execute the action plan involving interactions with various software tools.

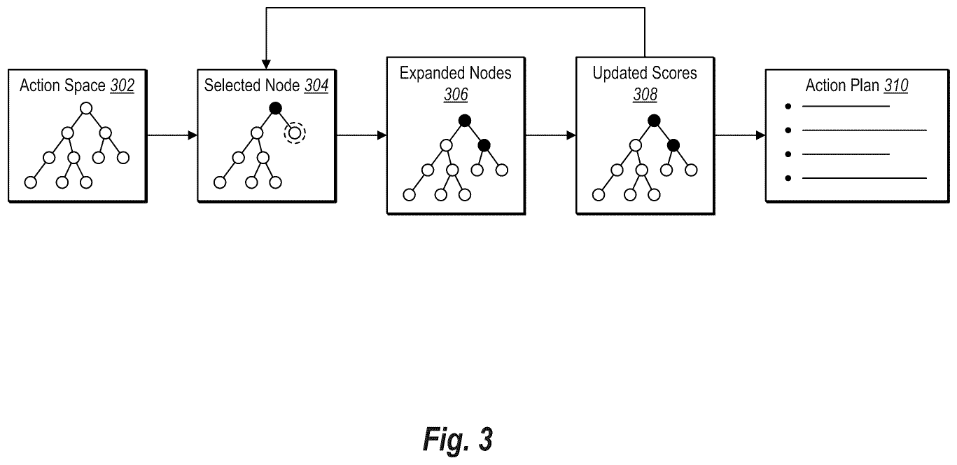

As illustrated in FIG. 2, the software action planning system 102 determines an action plan request 202 to generate an action plan including a sequence of computer processes to achieve a target within a computing environment. In at least some embodiments, the software action planning system 102 determines the action plan request 202 via one or more interactions with a client device in communication with a data management system (e.g., the data management system 110 of FIG. 1). Accordingly, as an example, the software action planning system 102 determines the action plan request 202 from an input to a large language model 204 to generate an action plan including a sequence of steps for accessing one or more databases to identify segments to increase revenue during a particular season. As an additional example, the software action planning system 102 determines the action plan request 202 from an input to the large language model 204 to generate an action plan including a sequence of steps for navigating within a virtual environment (e.g., to “take a shower” in a virtual home environment). FIG. 3 and the corresponding description provide additional detail related to the software action planning system 102 generating an action plan by exploring an action space.

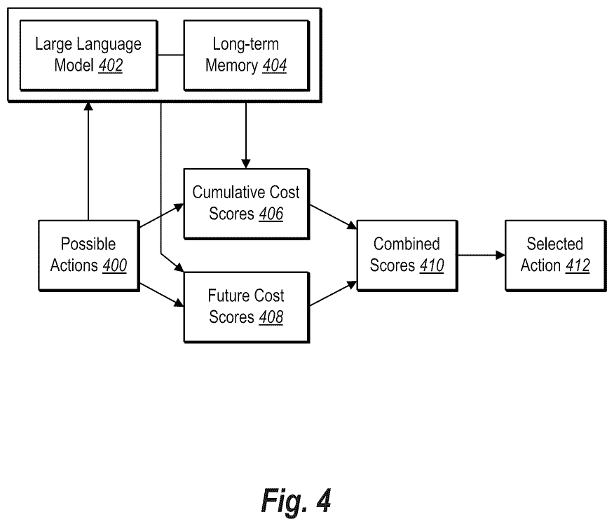

In response to determining the action plan request 202, the software action planning system 102 utilizes the large language model 204 to generate an action plan 206 to achieve the indicated target. Specifically, the software action planning system 102 utilizes the large language model 204 (e.g., via an agent that communicates with the large language model 204) with a best-first search model to explore an action space involving software tools 208 and generate the action plan 206. For instance, the software action planning system 102 utilizes the large language model 204 to perform a best-first search and select specific actions in an action space associated with the software tools 208 by generating various cost scores associated with the actions. Furthermore, in some embodiments, the software action planning system 102 generates the action plan 206 by causing the large language model 204 to interact with the software tools 208 when exploring/selecting actions and expanding the action space during one or more intermediate steps to reach the target. FIGS. 4-6 and the corresponding description provide additional detail related to generating cost scores for actions in an action space.

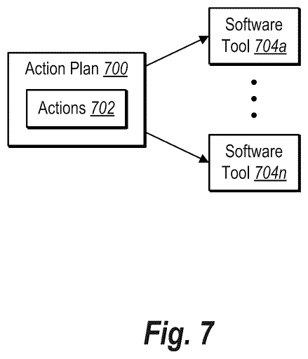

In some embodiments, the software action planning system 102 executes the action plan 206 by performing the actions in the action plan 206. For instance, the software action planning system 102 executes the action plan 206 by interacting with the software tools 208 according to the selected actions in the action plan 206. To illustrate, the software action planning system 102 executes the action plan 206 by performing one or more API calls or otherwise interacting with the software tools 208 indicated by the actions. Additionally, in some embodiments, the software action planning system 102 executes the action plan 206 by providing the action plan 206 to a client device for approval/confirmation and initialization of the action plan 206. In alternative embodiments, the software action planning system 102 executes the action plan 206 by automatically executing the computing operations associated with the actions of the action plan 206 in response to generating the action plan 206. FIG. 7 and the corresponding description provide additional detail related to executing an action plan.

As mentioned, FIG. 3 illustrates an example of the software action planning system 102 generating an action plan by utilizing a best-first search model to explore an action space. In particular, as mentioned, FIG. 3 illustrates that the software action planning system 102 determines an action space 302 including a set of actions. For instance, in response to a request to generate an action plan, the software action planning system 102 determines the action space 302 including an initial action or an initial set of possible actions. Furthermore, in some embodiments, the action space 302 includes a set of previously explored actions, including selected and/or not selected actions. In one or more embodiments, the action space 302 is represented as a decision tree (or search tree) with nodes representing actions in the action space 302.

In one or more embodiments, the software action planning system 102 explores the action space 302 by utilizing a large language model with a best-first search model to select actions within the action space according to specific costs. Specifically, the software action planning system 102 utilizes an iterative process to identify possible actions, select actions, and expand the action space 302. For example, the software action planning system 102 utilizes the best-first search model to determine a sequence of actions resulting in the shortest path that reaches the target of the request. Additionally, as mentioned, the software action planning system 102 utilizes a large language model to explore the action space 302 with the best-first search model.

As illustrated in FIG. 3, the software action planning system 102 performs an iterative process to search the action space 302 by determining a selected node 304 from the action space 302. In one or more embodiments, the software action planning system 102 determines the selected node 304 from a set of possible nodes. For instance, the software action planning system 102 determines a set of possible actions from a current node (or from a starting point selecting a first node) in the action space 302 by utilizing a large language model to generate the set of action nodes. To illustrate, the software action planning system 102 utilizes the large language model to determine the set of possible actions based on an initial prompt in the request and/or based on a prompt generated from a previously selected node. In some embodiments, the software action planning system 102 determines the set of possible actions from a pool of candidate actions (e.g., API calls or functions related to a set of software tools).

In response to determining the set of possible actions, the software action planning system 102 selects a node from the action space 302. Specifically, the software action planning system 102 utilizes a large language model with a best-first search model to determine costs for the set of possible actions. The software action planning system 102 selects an action having a lowest combined cost based on a corresponding cumulative cost score and future cost score of the corresponding node.

In one or more embodiments, the software action planning system 102 determines expanded nodes 306 based on the selected nodes 304. For example, the software action planning system 102 utilizes the large language model to determine a number of possible actions for the subsequent step. In particular, the software action planning system 102 utilizes the large language model to generate a possible action set given available software tools and demonstration examples in a dataset for the large language model. To illustrate, the software action planning system 102 utilizes the large language model to determine the set of possible actions in the action space 302 from the position of the selected node 304.

Additionally, as illustrated in FIG. 3, the software action planning system 102 determines updated scores 308 for the expanded nodes 306. Specifically, the software action planning system 102 generates updated cumulative cost scores and future cost scores for the possible actions corresponding to the expanded nodes 306. For instance, the software action planning system 102 utilizes the large language model with the best-first search model to generate the cost scores for the expanded nodes 306. In some embodiments, the software action planning system 102 repeats node selection, expansion, and score updating until reaching the target or fully exploring a branch of the action space 302. Accordingly, the software action planning system 102 explores the action space 302 by repeatedly selecting actions based on cost scores, expanding the action space 302 with additional possible actions for subsequent steps, and updating cost scores until reaching the target.

In one or more embodiments, the software action planning system 102 generates an action plan 310 in response to exploring the action space 302 via the iterative best-first search process. In particular, the software action planning system 102 generates the action plan 310 to include a plurality of actions corresponding to nodes with the lowest cost scores. For example, the software action planning system 102 generates the action plan 310 including the actions in a sequence corresponding to an order of the nodes in the action space 302.

As mentioned, FIGS. 4-6 provide examples of the software action planning system 102 generating various cost scores in connection with exploring an action space to generate an action plan. Specifically, FIG. 4 illustrates an example of the software action planning system 102 generating cost scores for possible actions in an action space in connection with generating an action plan. More specifically, FIG. 4 illustrates that the software action planning system 102 utilizes a large language model to generate cumulative cost scores and future cost scores for the possible actions to use in selecting an action from the action space.

As illustrated, the software action planning system 102 determines possible actions 400 in a next step of an action plan. For instance, the next step of the action plan includes a first step, a final step, or any intermediate step for achieving a target based on a request to generate the action plan. To illustrate, the possible actions 400 include one or more sets of processing instructions to perform one or more computing operations in connection with achieving the target. In some embodiments, the possible actions 400 include processing instructions to interact with one or more software tools. In additional embodiments, the software action planning system 102 utilizes the large language model to determine actions and possible actions for non-software related tasks, such as performing mathematical calculations, operational planning for an entity, or other tasks.

In one or more embodiments, the software action planning system 102 utilizes a large language model 402 and a long-term memory 404 associated with the large language model 402 to generate the cost scores. In particular, the software action planning system 102 utilizes a cost function involving the large language model 402 and the long-term memory 404 to generate cost scores of the possible actions 400. Furthermore, the software action planning system 102 selects actions to minimize the total cost of the final action plan.

In one or more embodiments, generating costs via the cost function includes the software action planning system 102 generates cumulative cost scores 406 for the possible actions 400 by assessing the cumulative cost of actions in the current action plan. For instance, the software action planning system 102 generates the cumulative cost scores 406 for the possible actions 400 indicating costs associated with one or more current selected paths including the possible actions (e.g., based on ancestor actions/nodes) and historical action plans generated by the large language model. To illustrate, the software action planning system 102 utilizes a function to generate a cumulative cost score by determining the individual cost scores of a plurality of ancestor nodes of a currently evaluated node in the action space and sums the costs of the ancestor nodes. Furthermore, the software action planning system 102 utilizes data from the long-term memory 404 of the large language model 402 to generate the cumulative cost scores 406.

Additionally, the software action planning system 102 generates future cost scores indicating estimated costs associated with a predicted action plan and historical action plans generated by the large language model 402. For instance, the software action planning system 102 utilizes an additional function to generate the future cost scores 408 based on data generated by the large language model 402 and data stored in the long-term memory 404. As an example, the software action planning system 102 utilizes the additional function to generate a future cost score by determining a similarity between a current action plan and a predicted future plan and heuristics of previously generated action plans.

In some embodiments, the software action planning system 102 utilizes the cumulative cost scores 406 and the future cost scores 408 to determine combined scores 410 for the possible actions 400. For example, the software action planning system 102 generates the combined scores 410 by summing the cumulative cost scores 406 and the future cost scores 408 for the respective possible actions. In additional embodiments, the software action planning system 102 determines a weighted combination of the cumulative cost scores 406 and the future cost scores 408.

In response to generating the combined scores 410, the software action planning system 102 determines a selected action 412. Specifically, the software action planning system 102 determines the selected action 412 by identifying a possible action that results in the lowest score for the current plan. More specifically, the software action planning system 102 determines the selected action 412 that results in minimizing the overall cost in combination with previously selected actions and potential future actions.

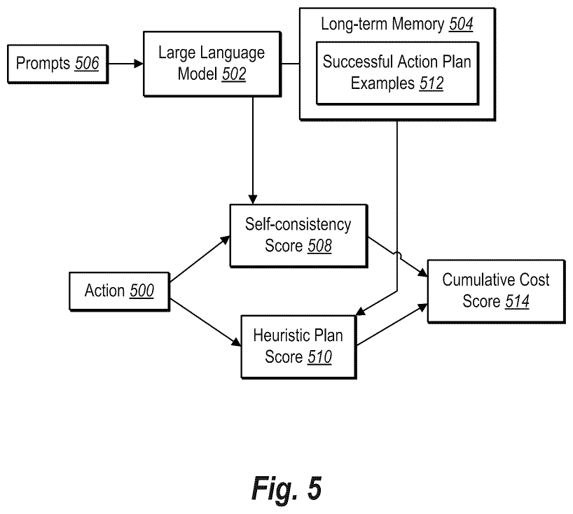

In one or more embodiments, as mentioned, the software action planning system 102 generates a cumulative cost score for an action by utilizing a large language model and a long-term memory. FIG. 5 illustrates an example of the software action planning system 102 generating a cumulative cost score for an action. For example, the software action planning system 102 generates a cumulative cost score for an action by leveraging the large language model to generate data and data previously generated by the large language model in a long-term memory.

In some embodiments, the software action planning system 102 determines an action 500 to evaluate from a set of possible actions in an action space. The software action planning system 102 utilizes a large language model 502 and a long-term memory 504 to generate and combine a plurality of different value functions to generate a cumulative cost score 514 for the action 500. FIG. 5 illustrates that the software action planning system 102 utilizes the large language model 502 and the long-term memory 504 to generate a self-consistency score 508 and a heuristic plan score 510 for the action 500.

In one or more embodiments, the software action planning system 102 utilizes the large language model 502 to generate the self-consistency score 508 in connection with the action 500. In particular, the software action planning system 102 utilizes issues prompts 506 to the large language model 502 to determine a set of possible actions including the action 500. For example, the software action planning system 102 issues prompts 506 to the large language model 502 based on a previously selected action.

Based on responses generated by the large language model 502 to the prompts 506, the software action planning system 102 generates the self-consistency score 508 to determine a consistency of the large language model 502. Specifically, the software action planning system 102 generates the self-consistency score 508 by determining proportions of semantically similar responses generated by the large language model 502 in response to the prompts 506. For instance, the software action planning system 102 determines how many times the large language model 502 generates a given response (or semantically similar variants of the response) relative to a total number of responses generated by the large language model 502 for the prompts 506. Furthermore, in some embodiments, the software action planning system 102 generates the self-consistency score 508 by determining proportions of semantically distinct actions of the set of possible actions. The software action planning system 102 generates the self-consistency score 508 according to the proportions.

In one or more embodiments, the software action planning system 102 generates the heuristic plan score 510 according to data stored in the long-term memory 504 of the large language model 502. In particular, the software action planning system 102 generates the long-term memory 504 to include historical action plans generated utilizing the large language model 502, such as successful action plan examples 512. For instance, the successful action plan examples 512 include a seed set of demonstration examples from a dataset. In additional embodiments, the software action planning system 102 adds successful action plans generated using the large language model 502 in response to validating the successful action plans.

In at least some embodiments, the software action planning system 102 generates the heuristic plan score 510 by comparing the successful action plan examples 512 to a current action plan corresponding to the action 500. For example, the software action planning system 102 generates the heuristic plan score 510 by calculating a longest common sub-sequence score between the current action plan and a successful action plan example. The longest common sub-sequence score represents the longest chain of connected nodes that the current action plan shares with the successful action plan example. Accordingly, the software action planning system 102 generates the heuristic plan score 510 based on the highest longest common sub-sequence score relative to the successful action plan examples 512.

In response to generating the self-consistency score 508 and the heuristic plan score 510, the software action planning system 102 generates a cumulative cost score 514 for the action 500. Specifically, the software action planning system 102 combines the self-consistency score 508 and the heuristic plan score 510 using a weighting function. For example, the software action planning system 102 uses a weight parameter for a geometric mean to generate the cumulative cost score 514 from the self-consistency score 508 and the heuristic plan score 510.

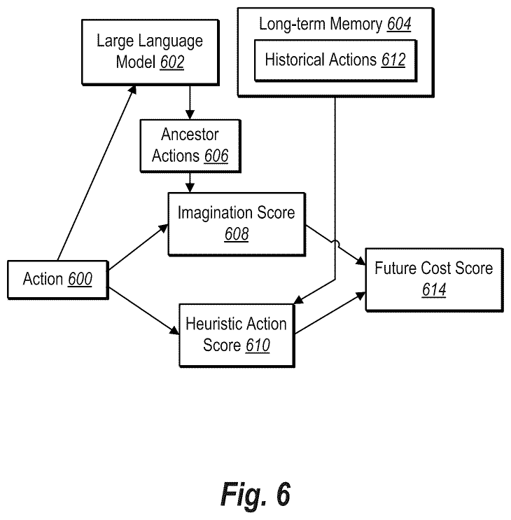

FIG. 6 illustrates an example of the software action planning system 102 generating a future cost score for a current action plan for a given node in an action space. For example, the software action planning system 102 generates the future cost score for an action 600 (e.g., a possible action at a particular step) by leveraging a large language model 602 to generate predicted data for a request and data previously generated by the large language model 602 in a long-term memory 604. More specifically, the software action planning system 102 generates the future cost score according to a combination of an imagination score 608 of the large language model 602 and a heuristic action score 610 based on data in the long-term memory 604.

In one or more embodiments, the software action planning system 102 generates the imagination score 608 as a representation of a future cost of the current action plan based on steps estimated by the large language model 602. In particular, the software action planning system 102 utilizes the large language model 602 to predict one or more future steps until reaching a target of a request. For example, the software action planning system 102 utilizes the large language model 602 to generate a predicted plan including one or more actions up until the action 600 from the current plan and one or more future steps from the action 600 to the target. The software action planning system 102 generates the imagination score 608 based on a ratio of the number of ancestor actions 606 of the action 600 (e.g., previously selected actions from an initial step in the current plan to the action 600) and the number of ancestor actions 606 to the target. Accordingly, a higher imagination score indicates that the predicted action plan captures the path to the current step at the action 600 with fewer steps remaining to reach the target.

Additionally, in one or more embodiments, the software action planning system 102 generates the heuristic action score 610 by accessing data from the long-term memory 604. For instance, the software action planning system 102 leverages the long-term memory 604 to determine historical actions 612 in successful action plan examples (e.g., as described above respect to FIG. 5). To illustrate, the software action planning system 102 determines relative positions of the historical actions 612 in the successful action plan examples. In some embodiments, the software action planning system 102 generates the heuristic action score 610 based on the relative position (e.g., according to a sub-sequence of the historical action) of the historical action form the long-term memory 604 that is lexically closest to the action 600.

In response to generating the imagination score 608 and the heuristic action score 610, the software action planning system 102 generates a future cost score 614 for the action. Specifically, the software action planning system 102 generates the future cost score 614 by combining the imagination score 608 and the heuristic action score 610 utilizing a weighted function. For example, the software action planning system 102 utilizes a geometric mean weight to combine the imagination score 608 and the heuristic action score 610 to generate the future cost score 614.

In one or more embodiments, as mentioned, the software action planning system 102 utilizes a cost function that determines and combines cumulative and future costs associated with actions to generate an action plan. For example, the software action planning system 102 leverages a large language model as an agent in a planning process by augmenting the large language model agent with access to a pool of m candidate API functions (e.g., software tools), denoted as [symbol] ={API₀, API₁, . . . , APIₘ}, along with a natural language task description g∈ [symbol] from the task space [symbol] . The software action planning system 102 determines an objective of the large language model agent including translating the task description g into an ordered sequence of T_{g} API function calls p_{g}={a₀, a₁, . . . , a_{T}_{_{g}}}. Specifically, considering the task description g as the initial state s₀, the software action planning system 102 samples the action plan p_{g} by prompting the large language model agent with the API definitions [symbol] and demonstration samples [symbol] as: p_{g}˜ρ(a₀, a₁, . . . , a_{T}_{_{g}}|s₀; [symbol] , [symbol] ): [symbol] × [symbol] × [symbol] →Δ( [symbol] ^{Tis g}), where Δ(⋅) is a probability simplex function. The final output is derived after executing the entire plan y˜π(y|s₀, a₁, a₂, . . . , a_{T}_{_{g}}), where π(⋅) indicates an action plan executor.

Furthermore, as mentioned, the software action planning system 102 utilizes a specialized tree search-based method including a best-first search model to explore an action space. In one or more embodiments, tree search-based methods frame a planning problem as a search over a decision tree, where each node n represents an action aₙ, accompanied by a state sₙ∈ [symbol] indicating a valid path from the initial state to the current action. When exploring the tree space, tree search approaches expand k potential child nodes ch(n) of the current node n via sampling from the potential action set generated by LLMs a_{ch(n)}^{j)}˜ρ(a_{ch(n)}|sₙ; [symbol] , [symbol] ), (j=1, . . . , k) and add the new nodes to the tree state space [symbol] = [symbol] ∪{(sₙ, a_{ch(n)}^{(j)})}ⱼ₌₁^{k}. With value functions for state evaluation, tree search-based methods aim to identify a path from the root node s₀ to the leaf nodes with the highest value or lowest cost. Specifically, the software action planning system 102 utilizes a best-first search model (e.g., A* search) that uses a single large language model call to determine the next actions during expansion according to two cost functions, g(n), which quantifies the cost of the path from the root node to n, and h(n), which is a heuristic function estimating the cost of the most promising (e.g., cheapest) path from n to the target. In one or more embodiments, the software action planning system 102 selects the path that minimizes ƒ(n)=g(n)+h(n).

In one or more embodiments, the software action planning system 102 formulates the action space as a search tree [symbol] , where each node n represents an action aₙ, accompanied by a state composed of the initial task description so and previous actions. This facilitates the translation of action sequence planning into a navigation task originating from the root node of the decision tree. The software action planning system 102 starts the search tree [symbol] with a single root node, corresponding to the input input problem description so. At each step, the software action planning system 102 selects a node n from the frontiers of [symbol] (denoted as [symbol] ( [symbol] )) according to the cost function. The software action planning system 102 expands n with the large language model to generate a set of k potential i.i.d. actions {a_{ch(n)}^{(j)}}ⱼ₌₁^{k} for the next step and grows [symbol] with the generated actions. The software action planning system 102 updates the actions into new nodes s_{ch(n)}^{(j)}=(sₙ, a_{ch(h)}^{(j)}) and update their cost functions accordingly. Algorithm 1 below describes the procedure in detail.

Algorithm 1: ToolChain*.

```
Input: x: input; ρ: large language model; T: the maximum exploring steps; [symbol]   : the decision tree; [symbol]
( [symbol]   ): the set of frontier nodes in [symbol]   ; f(n): the cost function of node n.
Initialize [symbol]   = { [symbol]   , [symbol]   }, [symbol]   ← x, [symbol]   ← Ø
for t = 1,2, ... , T do
  nₙₑₓₜ ← arg [symbol]   f(n) // Selection
  {a^{(I)}}ᵢ₌₁^{k} ← ρ(nₙₑₓₜ) // Expansion
  for i = 1,2, ... , k do
    Add [nₙₑₓₜ, a⁽ⁱ⁾] to [symbol]   under nₙₑₓₜ
  Update f(n) for n in [symbol]   ( [symbol]   ). // Update
Output: The valid path to solve the problem argmax_{n∈} [symbol]   ₍ [symbol]   ₎ f(n).
```

In response to selecting the node n with the minimum cost estimation ƒ(n), the software action planning system 102 expands the search tree with k potential actions for the next step. The software action planning system 102 samples these actions from the potential action set generated by the large language model a_{ch(n)}^{(j)}˜ρ(a_{ch(n)}|sₙ; [symbol] , [symbol] ) (j=1, . . . , k), given the API definitions [symbol] and demonstration examples [symbol] . For the generated actions or reasoning steps {a_{ch(n)}^{(j)}}ⱼ₌₁^{k}, the software action planning system 102 establishes their corresponding nodes under node n. Contrasting with the approach in a Monte Carlo search tree, which requires multiple calls to ρ until a terminal state during rollout, the software action planning system 102 utilizes a single call to generate the possible actions at the next step.

In one or more embodiments, the software action planning system 102 denotes the search tree [symbol] after expansion of node n as [symbol] . Given that new nodes have been incorporated and the original tree structure has changed, the software action planning system 102 updates the frontier nodes as [symbol] ( [symbol] ). With the newer frontier nodes n∈ [symbol] ( [symbol] ), the software action planning system 102 computes their corresponding cost functions for the next selection-expansion-update iteration.

Specifically, In one or more embodiments, during the planning process, the software action planning system 102 assesses the cumulative cost of actions in the current plan and guides the planning based on the assessment. Specifically, for each node n in the searching tree, the software action planning system 102 uses a single-step value function gₜ(n) ranging from 0 to 1 and formulate the cost as its complement 1−g_{g}(n). Thus, the software action planning system computes the cumulative cost of n by summing up all the single-step costs of its ancestor nodes an(n): g(n)=Σ_{i∈an(n)}1−gₜ(i). More specifically, the software action planning system 102 combines two different value functions, the heuristic plan score from reference data (long-term memory) g_{t,1}(n) and the self-consistency score by LLM g_{t,2}(n), to compute cumulative cost g(n):

$$g ( n ) = {\sum }_{i ∈ \{ an ( n ) , n \}} ( 1 - {{g}_{t , 1} ( i )}^{α} \cdot {( 1 - {g}_{t , 2} ( i ) )}^{1 - α} ,$$

where α is a weight parameter for the geometric mean.

In one or more embodiments, the software action planning system 102 also maintains a long-term memory with successful experiences and computes a heuristic plan score accordingly. In some embodiments, the long-term memory starts from a seed set of demonstration examples provided in a specific dataset and is iteratively extended with successful plans during evaluation. Each example within the long-term memory is represented as a plan mⱼ=(s_{j,0}, a_{j,1}, a_{j,2}, . . . , a_{j,T}_{ⱼ})∈ [symbol] . The number of actions Tⱼ in the plan varies case-by-case. To leverage the successful experiences for evaluating the current plan, the software action planning system 102 computes the longest common sub-sequence (LCS) score between the current generated plan sₙ and each plan mⱼ in the long-term memory

$$LCS\_score ( {s}_{n} , {m}_{j} ) = \frac{LCS ( {s}_{n} , {m}_{j} )}{min ( L ( {s}_{n} ) , L ( {m}_{j} ) )} ,$$

where L(⋅) indicates the length of the plan. The software action planning system 102 computes the heuristic plan score as the highest LCS score g_{t,1}(n)=

$${max}_{{m}_{j} ∈ ℳ}$$

LCS_score(sₙ,mⱼ), measuring the proportion of success in the plan relative to the experiences accumulated in the long-term memory.

In one or more embodiments, the software action planning system 102 generates the self-consistency score using an ensemble approach that samples k i.i.d. actions at the next step {aₜ₊₁^{(j)}}ⱼ₌₁^{k}˜p(a_{t|1}x, a₀, a₁, . . . , aₜ). The software action planning system 102 selects the semantically different actions from the k generated samples as the set of potential next steps. For tool-use scenarios, as the actions are strict in format of API functions and parameters, the software action planning system 102 directly constructs the set with non-repeating actions. For reasoning scenarios, however, actions represent intermediate thought processes articulated in natural language. In one or more embodiments, the software action planning system 102 applies a language understanding neural network fine-tuned on a natural language inference dataset to determine whether the two generated actions entail each other semantically. The software action planning system 102 discards actions that are semantically equivalent and only retaining those that offer distinct reasoning as potential next steps. The software action planning system 102 considers the frequencies of different actions in the set as their corresponding cumulative score, given by g_{t,2}(n)=#{j|tₐ₊₁^{(j)}=n}/k.

Similar to the formulation of cumulative cost g(n), the software action planning system 102 integrates two distinct reward functions, a heuristic action function h_{t,1}(n) and an imagination score of the large language model h_{t,2}(n), to compute h(n):

$$h ( n ) = {( 1 - {h}_{t , 1} ( n ) )}^{β} \cdot {( 1 - {h}_{t , 2} ( n ) )}^{1 - β} ,$$

where β is the geometric mean weight for future cost.

Similar to the heuristic plan function in the cumulative cost, the software action planning system 102 leverages the long-term memory to compute the future score. From the long-term memory, the software action planning system 102 derives the average relative position score of the action a appearing in the plans mⱼ:

$${h}_{t , 1} ( a ) = {\sum }_{{m}_{j} ∈ ℳ} {\{ a ∈ {m}_{j} \}}_{} \frac{pos ( a , {m}_{j} )}{{T}_{j}} ,$$

where pos(a, mⱼ) indicates the relative position of action a in the plan mⱼ. Because the action space can be infinite, in some embodiments, the long-term memory does not cover all potential actions relevant to unseen tasks. Thus, given an action node n, the software action planning system 102 computes a future cost score as the heuristic action score of the lexically closes action covered in the long-term memory: h_{t,1}(n)=h_{t,1}(arg [symbol] LCS_score(n, a)).

In one or more embodiments, the software action planning system 102 enables the large language model to imagine more concrete future steps until the target n_{T}. In some implementations, the software action planning system 102 computes the future cost score as the proportion of current steps present in the imagined plan, i.e., the ratio of the number between the current node n ancestors to the target node n_{T}:

$${h}_{t , 2} ( n ) = \frac{\vert \{ an ( n ) \} \vert}{\vert \{ an ( {n}_{T} ) \} \vert} .$$

A higher score suggests that the imagined plan closely captures the path to the current step, indicating that fewer remaining steps remain to accomplish the task in the imagination of large language model.

In one or more embodiments, in response to generating an action plan, the software action planning system 102 executes the action plan. FIG. 7 illustrates an example of the software action planning system 102 executing an action plan 700 by executing actions 702 in the action plan 700. For example, the software action planning system 102 executes the action plan 700 by interacting with a plurality of software tools 704a-704n. To illustrate, the software action planning system 102 executes a first action in the action plan 700 by causing a computing device to interact with a first software tool 704a, such as by performing a first API call to perform a first computing operation. Additionally, the software action planning system 102 executes additional actions in the action plan 700 by performing one or more computing operations or by causing a computing device to interact with one or more additional software tools.

In some embodiments, the software action planning system 102 executes the action plan 700 by leveraging the large language model to execute one or more of the actions 702. In particular, the software action planning system 102 utilizes the large language model to execute the action plan 700 in response to generating the action plan 700 by interacting with one or more software tools corresponding to the actions 702 in an order determined according to the action plan 700. Alternatively, the software action planning system 102 utilizes the large language model to provide the action plan 700 for display at a client device.

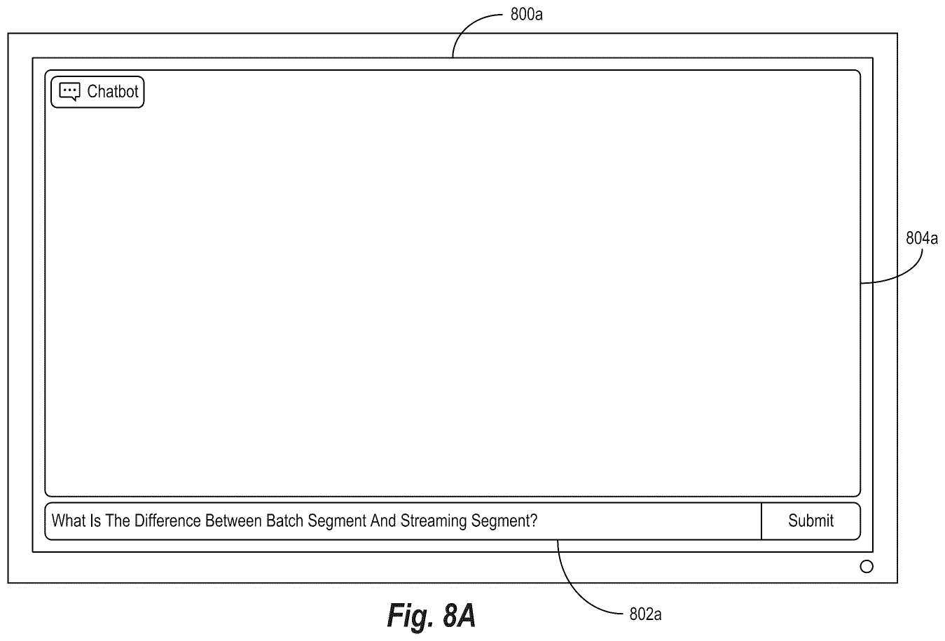

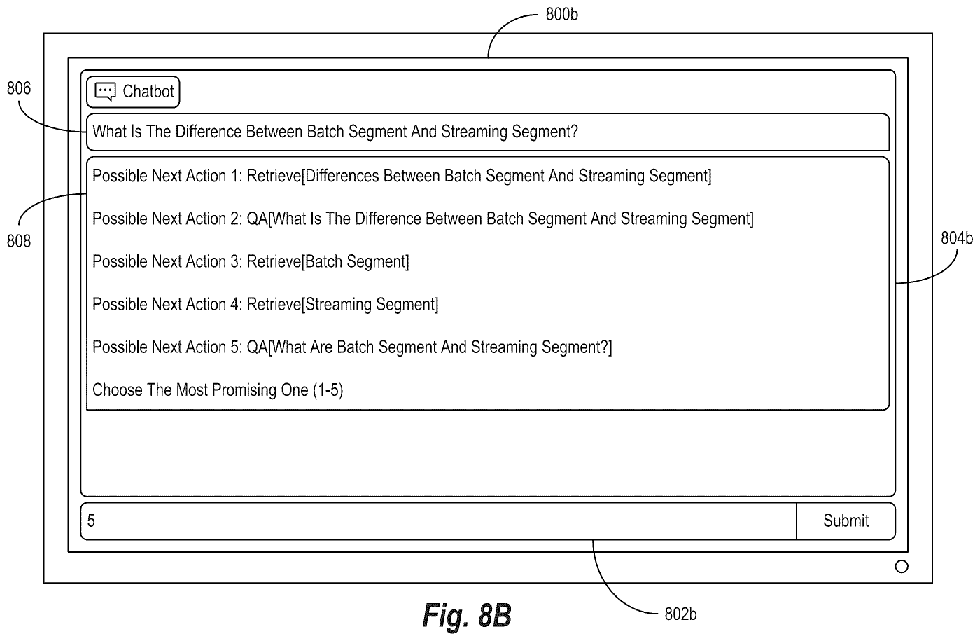

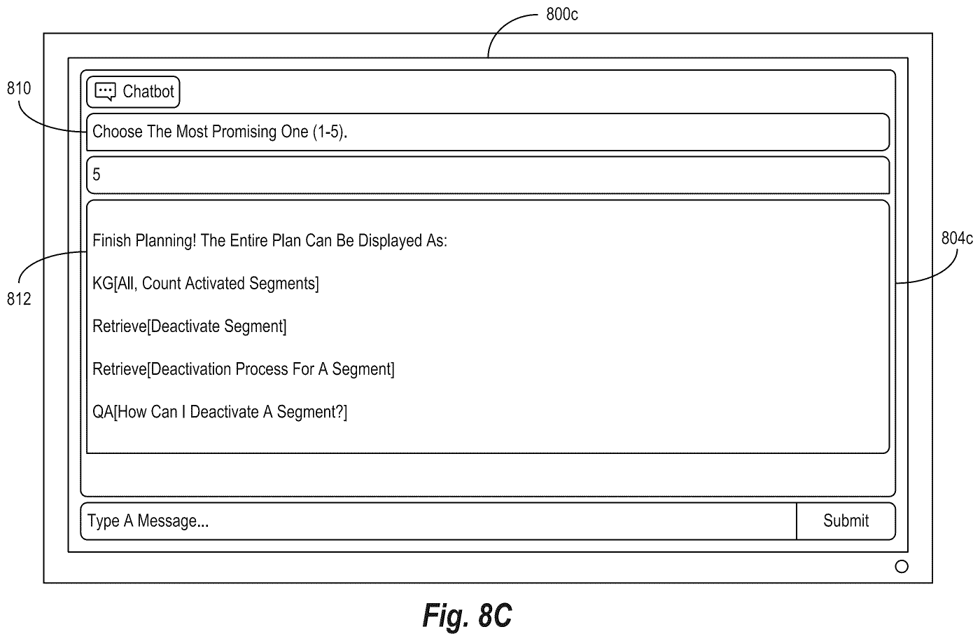

FIGS. 8A-8C provide examples of graphical user interfaces for generating an action plan utilizing a large language model. For example, FIG. 8A illustrates that a client device displays a graphical user interface 800a including a chat session with a large language model. As illustrated, the graphical user interface 800a includes an input portion 802a for inputting a request to the large language model. Additionally, the graphical user interface 800a includes a message portion 804a with a message history of messages input by a user and messages generated by the large language model.

In one or more embodiments, for example, the software action planning system 102 determines an action plan request in response to an input by a user via the input portion 802a of the graphical user interface 800a. For instance, the software action planning system 102 determines an action plan request in response to a request “What is the difference between batch segment and streaming segment?” To illustrate, the action plan involves one or more computing operations to access various software tools associated with a batch segment and a streaming segment.

FIG. 8B illustrates a graphical user interface 800b including messages generated by a user and the large language model. In particular, the client device displays a message history in a message portion 804b of the graphical user interface. The message portion 804b includes a first message 806 based on the input provided to the client device, as illustrated in FIG. 8A. Additionally, the message portion 804b includes a second message 808 generated by the large language model in response to the first message 806.

As shown, the second message 808 includes a plurality of possible next actions in a subsequent step of an action plan based on the initial request. In one or more embodiments, the software action planning system 102 utilizes the large language model to identify the plurality of possible next actions and present the actions for display at the client device. For example, the software action planning system 102 provides such information to obtain user feedback to increase data in a long-term memory for the large language model and/or to otherwise supplement the various cost scores. Accordingly, in response to a user input via an input portion 802b selecting one of the possible next actions (e.g., via a number input), the software action planning system 102 selects the next action according to the indicated action. Alternatively, the software action planning system 102 utilizes the large language model to identify possible next actions and also select an action without user involvement.

FIG. 8C illustrates a graphical user interface 800c of a client device including a completed action plan. For instance, the software action planning system 102 utilizes the large language model to generate an action plan based on one or more intermediate plans according to the request of FIG. 8A. To illustrate, the client device displays a plurality of messages in a message portion 804c of the graphical user interface 800c including one or more messages generated by the user and/or the large language model in connection with generating the action plan. As illustrated, the message portion 804c includes a first message 810 generated by the large language model indicating to the user to select a possible next action from a set of possible actions (e.g., as shown in FIG. 8B) and a second message 812 generated by the large language model including an indication of the action plan based on the user's input. Additionally, the large language model generates the action plan by interacting with one or more software tools according to actions in an action space based on the request.

In one or more embodiments, the software action planning system 102 provides the action plan for display at the client device. For example, the software action planning system 102 provides a list of actions in the action plan in the second message 812. In additional examples, the software action planning system 102 provides an option to execute the action plan by performing the actions in the action plan. Additionally, the software action planning system 102 executes (e.g., via the client device and/or the large language model accessing the one or more software tools) the action plan by performing the actions in a specific order in response to a selection of the option.

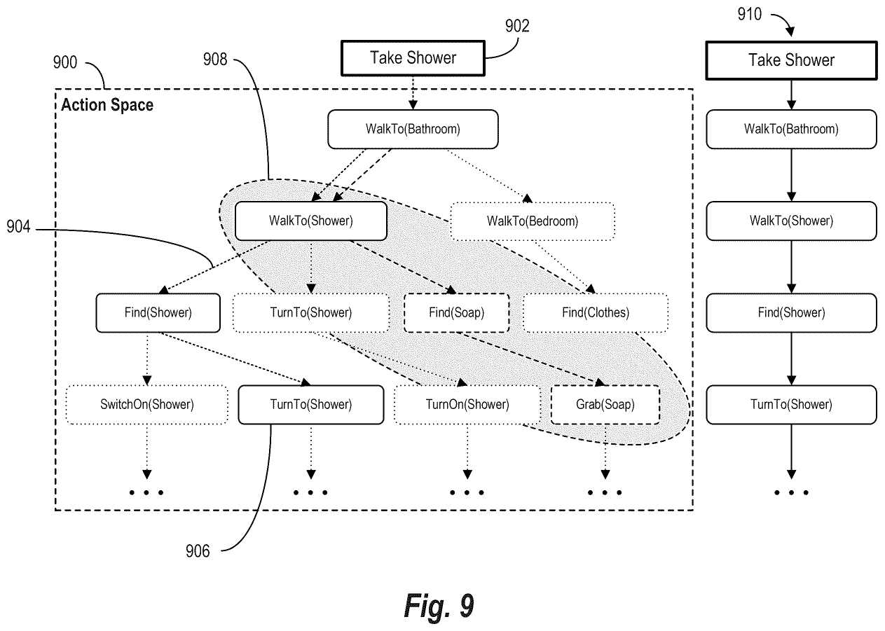

FIG. 9 illustrates an example of an action space 900 including a plurality of actions based on a request 902 to achieve a target (“Take Shower”) in a virtual environment. Additionally, FIG. 9 illustrates a path 904 selected by the software action planning system 102 utilizing a large language model with a best-first search model. For example, the path 904 includes a sequence of steps with a final action 906 that results in achieving the target. As shown, the software action planning system 102 explores a plurality of possible paths in the action space 900 utilizing a best-first search model in connection with selecting the path 904 for the action plan. FIG. 9 also shows an action plan 910 resulting from selecting the path 904 within the action space 900.

Furthermore, FIG. 9 illustrates a path 908 explored by a conventional system including a plurality of steps based on the target of the request 902. As illustrated, the conventional system explores a limited set of nodes in the action space 900 and arrives at an incorrect solution. In contrast, the software action planning system 102 explores a greater number of nodes in the action space 900 than the conventional system and selects the correct path to arrive at the correct solution.

Additionally, experiments were conducted to perform a variety of multi-step tasks in specific computing environments utilizing the software action planning system 102 and a plurality of conventional systems. More specifically, the multi-step tasks involve generating action plans for performing a home search utilizing an API of a home inventory site (“Home Search”), booking a trip via an API of a trip booking site (“Trip Booking”), and navigating a virtual environment (“Virtual Home”). Table 1 below includes success rates for the software action planning system 102 (“System 102”) and a plurality of conventional systems on the above tasks. Specifically, “ReAct” corresponds to a unidirectional search model (a greedy closed-loop system) as described by Shunyu Yao, Jeffrey Zhao, Dian Yu, Nan Du, Izhak Shafran, Karthik R. Narasimhan, and Yuan Cao in “React: Synergizing reasoning and acting in language models,” in The Eleventh International Conference on Learning Representations, 2023. Additionally, “MCTS” corresponds to a tree search-based model (Monte Carlo Tree Search) as described by Shibo Hao, Yi Gu, Haodi Ma, Joshua Jiahua Hong, Zhen Wang, Daisy Zhe Wang, and Zhiting Hu in “Reasoning with language model is planning with world model,” in arXiv preprint arXiv: 2305.14992, 2023.

| | Home | Trip | Virtual | |
|---|---|---|---|---|
| Models | Search | Booking | Home | Average |
| ReAct | 83.0 | 86.7 | 20.5 | 59.3 |
| MCTS | 85.0 | 86.7 | 24.4 | 64.8 |
| System 102 | 93.0 | 90.8 | 28.6 | 68.5 |

As indicated in Table 1, the software action planning system 102 generates action plans that result in higher accuracy than unidirectional conventional systems and higher or comparable accuracy than other tree search-based conventional systems. Furthermore, as previously mentioned, the software action planning system 102 provides greater efficiency than other tree search-based systems while providing comparable efficiency to unidirectional conventional systems. Thus, the software action planning system 102 improves computing accuracy and/or efficiency over conventional systems.

Table 2 below provides an ablation study indicating that individual components of the software action planning system 102 also provide improvements.

| | Home | Trip | Virtual | |
|---|---|---|---|---|
| | Search | Booking | Home | Average |
| System 102 | 93.0 | 90.8 | 28.6 | 68.5 |
| −g_{1, t}(n) | 91.0 | 88.3 | 22.6 | 65.5 |
| −g_{2, t}(n) | 84.0 | 83.3 | 25.3 | 61.7 |
| −h_{1, t}(n) | 88.0 | 87.5 | 23.0 | 65.0 |
| −h_{2, t}(n) | 85.0 | 85.8 | 24.9 | 61.8 |
| −g(n) | 61.0 | 34.9 | 21.0 | 40.3 |
| −h(n) | 84.0 | 85.8 | 26.1 | 62.3 |

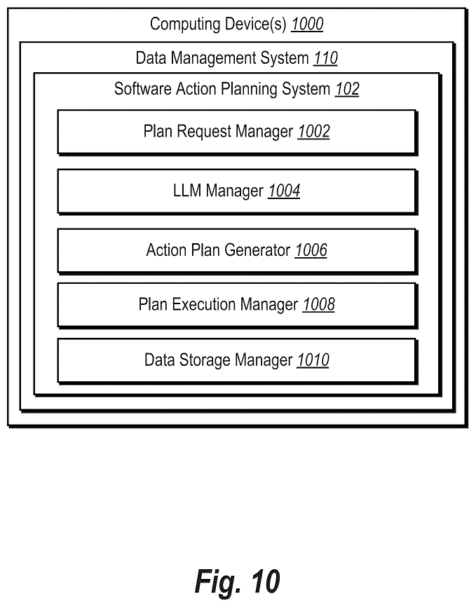

FIG. 10 illustrates a detailed schematic diagram of an embodiment of the software action planning system 102 described above. As shown, the software action planning system 102 is implemented in an data management system 110 on computing device(s) 1000 (e.g., a client device and/or server device as described in FIG. 1, and as further described below in relation to FIG. 12). Additionally, the software action planning system 102 includes, but is not limited to, plan request manager 1002, a LLM (large language model) manager 1004, an action plan generator 1006, a plan execution manager 1008, and a data storage manager 1010. In one or more embodiments, the software action planning system 102 is implemented on any number of computing devices. For example, the software action planning system 102 can be implemented in a distributed system of server devices for action planning. The software action planning system 102 can also be implemented within one or more additional systems. Alternatively, the software action planning system 102 can be implemented on a single computing device such as a single client device.

In one or more embodiments, each of the components of the software action planning system 102 is in communication with other components using any suitable communication technologies. Additionally, the components of the software action planning system 102 are capable of being in communication with one or more other devices including other computing devices of a user, server devices (e.g., cloud storage devices), licensing servers, or other devices/systems. It will be recognized that although the components of the software action planning system 102 are shown to be separate in FIG. 10, any of the subcomponents may be combined into fewer components, such as into a single component, or divided into more components as may serve a particular implementation. Furthermore, although the components of FIG. 10 are described in connection with the software action planning system 102, at least some of the components for performing operations in conjunction with the software action planning system 102 described herein may be implemented on other devices within the environment.

In some embodiments, the components of the software action planning system 102 include software, hardware, or both. For example, the components of the software action planning system 102 include one or more instructions stored on a computer-readable storage medium and executable by processors of one or more computing devices (e.g., the computing device(s) 1000). When executed by the one or more processors, the computer-executable instructions of the software action planning system 102 cause the computing device(s) 1000 to perform the operations described herein. Alternatively, the components of the software action planning system 102 include hardware, such as a special purpose processing device to perform a certain function or group of functions. Additionally, or alternatively, the components of the software action planning system 102 include a combination of computer-executable instructions and hardware.

Furthermore, the components of the software action planning system 102 performing the functions described herein with respect to the software action planning system 102 may, for example, be implemented as part of a stand-alone application, as a module of an application, as a plug-in for applications, as a library function or functions that may be called by other applications, and/or as a cloud-computing model. Thus, the components of the software action planning system 102 may be implemented as part of a stand-alone application on a personal computing device or a mobile device. Alternatively, or additionally, the components of the software action planning system 102 may be implemented in any application that provides digital image difference captioning, including, but not limited to ADOBE® ANALYTICS, ADOBE® EXPERIENCE CLOUD®, and ADOBE® TARGET software.

As illustrated, the software action planning system 102 includes a plan request manager 1002 to manage requests to generate action plans. In particular, the plan request manager 1002 manages one or more graphical user interfaces for presenting information associated with action planning and/or for receiving inputs in connection with action planning.

The software action planning system 102 also includes a LLM manager 1004 to manage one or more large language models for action planning. For example, the LLM manager 1004 selects one or more large language models to use in connection with generating action plans. Additionally, the LLM manager 1004 manages API calls to one or more large language models for generating one or more action plans.

The software action planning system 102 also includes an action plan generator 1006 to generate action plans utilizing one or more large language models. For example, the action plan generator 1006 communicates with the LLM manager 1004 to interact with a large language model to explore an action space using a best-first search model in connection with a request to generate an action plan. Additionally, the action plan generator 1006 generates an action plan including various selected actions in response to exploring an action space.

The software action planning system 102 includes a plan execution manager 1008 to execute action plans generated via the action plan generator 1006. For instance, the plan execution manager 1008 provides a generated action plan for display at a client device to execute an action plan. Alternatively, the plan execution manager 1008 automatically executes a generated action plan in connection with generating the action plan utilizing a large language model. For example, the plan execution manager 1008 interfaces with one or more software tools to implement actions in an action plan.

The software action planning system 102 also includes a data storage manager 1010 (that comprises a non-transitory computer memory) that stores and maintains data associated with generating action plans. For example, the data storage manager 1010 stores data associated with action plan requests, action spaces, and generated action plans. In some embodiments, the data storage manager 1010 stores data for a large language model, including data to issue API calls to a large language model and/or to store and train the large language model.

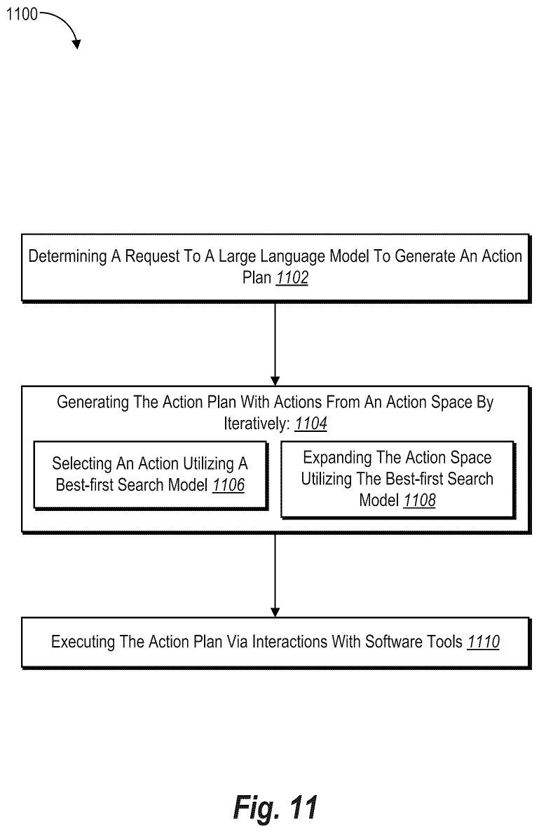

Turning now to FIG. 11, this figure shows a flowchart of a series of acts 1100 of generating action plans utilizing a large language model with a best-first search model. While FIG. 11 illustrates acts according to one embodiment, alternative embodiments may omit, add to, reorder, and/or modify any of the acts shown in FIG. 11. The acts of FIG. 11 are part of a method. Alternatively, a non-transitory computer readable medium comprises instructions, that when executed by one or more processors, cause the one or more processors to perform the acts of FIG. 11. In still further embodiments, a system includes a processor or server configured to perform the acts of FIG. 11.

As shown, the series of acts 1100 includes an act 1102 of determining a request to a large language model to generate an action plan. The series of acts 1100 also includes an act 1104 of generating the action plan with actions from an action space. In particular, act 1104 involves iteratively performing act 1106 of selecting an action utilizing a best-first search model and act 1108 of expanding the action space utilizing the best-first search model. Additionally, the series of acts 1100 includes an act 1110 of executing the action plan via interactions with software tools.

In one or more embodiments, act 1102 involves determining a request to utilize a large language model to generate an action plan via one or more software tools. Act 1104 involves generating the action plan by traversing a decision tree comprising an action space involving the one or more software tools. Additionally, act 1104 involves iteratively performing act 1106, which involves selecting, utilizing a best-first search model, an action from a set of possible actions in the action space of the decision tree, and act 1108, which involves expanding, utilizing the best-first search model, the action space of the decision tree to include an additional set of possible actions. Act 1110 involves executing the action plan via one or more interactions with the one or more software tools according to the action.

In one or more embodiments, act 1106 involves selecting, utilizing a best-first search model, an action from a set of possible actions to interact with the one or more software tools according to a cumulative cost score of the action and a future cost score of a set of future possible actions. For example, the cumulative cost score is generated from a self-consistency frequency score of the large language model for the action; and a heuristic plan score based on a long-term memory associated with the large language model.

In one or more embodiments, act 1108 involves selecting, utilizing a best-first search model, an action from a set of possible actions to interact with the one or more software tools according to a cumulative cost score of the action and a future cost score of a set of future possible actions. For example, the future cost score is generated from a heuristic action score based on a long-term memory associated with the large language model; and an imagination score corresponding to a predicted action plan generated by the large language model to reach a target for the request.

In one or more embodiments, the series of acts 1100 includes generating, via a plurality of prompts to the large language model, cumulative cost scores indicating costs of executing possible actions in the set of possible actions in the action space of the decision tree. The series of acts 1100 also includes generating future cost scores for a set of future possible actions to complete the action plan. The series of acts 1100 further includes selecting the action from the set of possible actions in response to determining that the action has a lowest combined score based on a cumulative cost score of the action and a future cost score associated with the action.

In some embodiments, the series of acts 1100 includes determining one or more cumulative cost scores of one or more ancestor actions of the action; and summing the one or more cumulative cost scores of the one or more ancestor actions to generate a cumulative cost score for the action.

In some embodiments, the series of acts 1100 includes generating, for the action, a self-consistency score of the large language model by determining a frequency of responses by the large language model indicating one or more actions including the action. The series of acts 1100 also includes generating a heuristic plan score by comparing the action plan to successful action plan examples in a long-term memory associated with the large language model; and generating a cumulative cost score of the action based on a combination of the self-consistency score and the heuristic plan score.

In one or more embodiments, the series of acts 1100 includes generating longest common sub-sequence scores between the action plan and the successful action plan examples in the long-term memory; and selecting a longest common sub-sequence score with a highest value as the heuristic plan score.

In one or more embodiments, the series of acts 1100 includes determining a subset of possible actions that are non-repeating for a subsequent step of the action plan, the subset of possible actions comprising the action. The series of acts 1100 also includes in response to a prompt executed in connection with the subset of possible actions to the large language model a plurality of times, determining frequencies of occurrence of possible actions of the subset of possible actions from responses generated by the large language model. The series of acts 1100 further includes generating the self-consistency score based on a frequency of occurrence of the action.

In some embodiments, the series of acts 1100 includes generating a heuristic action score by comparing the action to historical actions in successful action plan examples in a long-term memory associated with the large language model. The series of acts 1100 also includes generating an imagination score indicating a proportion of one or more previously selected actions present of the action plan in a predicted action plan to reach a target for the request. The series of acts 1100 also includes generating a future cost score for the action based on a combination of the heuristic action score and the imagination score. The series of acts 1100 further includes generating the heuristic action score in response to determining, from the successful action plan examples in the long-term memory of the large language model, a historical action that is lexically closest to the action.

The series of acts 1100 also includes executing a prompt to the large language model to generate a predicted action plan including one or more future possible actions to reach the target for the request. The series of acts 1100 also includes generating, for the action, the imagination score indicating a proportion of ancestor actions of the action in the predicted action plan.

In one or more embodiments, the series of acts 1100 includes providing one or more prompts to the large language model to perform a plurality of actions in the action plan by executing one or more application programming interface calls of the one or more software tools. Additionally, the series of acts 1100 includes determining a frequency of responses indicating one or more actions including the action by the large language model to a plurality of prompts. In some embodiments, the series of acts 1100 further includes comparing a subsequence of actions of the action plan to subsequences of actions of successful action plan examples in the long-term memory of the large language model.

Furthermore, the series of acts 1100 includes generating a heuristic action score based on a position of the action in the action plan relative to a lexically similar action in the long-term memory of the large language model. The series of acts 1100 includes generating an imagination score based on a ratio of one or more ancestor actions of the action in the action plan to actions to reach a target for the request in a predicted action plan. Additionally, the series of acts 1100 includes generating the future cost score based on a combination of the heuristic action score and the imagination score.

In some embodiments, the series of acts 1100 includes determining, utilizing the best-first search model, a plurality of actions in the action space resulting in a lowest combined plan cost according to cumulative cost scores of the plurality of actions. Additionally, the series of acts 1100 includes providing, for display via a graphical user interface of a client device, the action plan including the plurality of actions and indications of corresponding application programming interface calls of the one or more software tools.

In some embodiments, the series of acts 1100 includes determining a successful action plan example in response to one or more user interactions indicating that a previous action plan generated is successful. Additionally, the series of acts 1100 includes adding the successful action plan example to the long-term memory.

In one or more embodiments, the series of acts 1100 includes determining average relative positions scores of historical actions in successful action plan examples in a long-term memory associated with the large language model. Additionally, the series of acts 1100 includes generating the heuristic action score utilizing an average relative position score of a historical action that is lexically closest to the action.

According to one or more embodiments, the series of acts 1100 includes causing the large language model to generate a predicted action plan to reach a target for the request. Additionally, the series of acts 1100 includes determining a proportion of one or more previously selected actions of the action plan in the predicted action plan; and generating the imagination score based on the proportion.

In one or more embodiments, the series of acts 1100 includes generating a self-consistency score of the large language model indicating a frequency of responses by the large language model to a plurality of prompts based on the action. The series of acts 1100 also includes generating a heuristic plan score based on a similarity of the action plan to a successful action plan example in the long-term memory; and generating the cumulative cost score of the action by combining the self-consistency score and the heuristic plan score.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction and scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 12 illustrates a block diagram of exemplary computing device 1200 that may be configured to perform one or more of the processes described above. One will appreciate that one or more computing devices such as the computing device 1200 may implement the system(s) of FIG. 1. As shown by FIG. 12, the computing device 1200 can comprise a processor 1202, a memory 1204, a storage device 1206, an I/O interface 1208, and a communication interface 1210, which may be communicatively coupled by way of a communication infrastructure 1212. In certain embodiments, the computing device 1200 can include fewer or more components than those shown in FIG. 12. Components of the computing device 1200 shown in FIG. 12 will now be described in additional detail.

In one or more embodiments, the processor 1202 includes hardware for executing instructions, such as those making up a computer program. As an example, and not by way of limitation, to execute instructions for dynamically modifying workflows, the processor 1202 may retrieve (or fetch) the instructions from an internal register, an internal cache, the memory 1204, or the storage device 1206 and decode and execute them. The memory 1204 may be a volatile or non-volatile memory used for storing data, metadata, and programs for execution by the processor(s). The storage device 1206 includes storage, such as a hard disk, flash disk drive, or other digital storage device, for storing data or instructions for performing the methods described herein.

The I/O interface 1208 allows a user to provide input to, receive output from, and otherwise transfer data to and receive data from computing device 1200. The I/O interface 1208 may include a mouse, a keypad or a keyboard, a touch screen, a camera, an optical scanner, network interface, modem, other known I/O devices or a combination of such I/O interfaces. The I/O interface 1208 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1208 is configured to provide graphical data to a display for presentation to a user. The graphical data may be representative of one or more graphical user interfaces and/or any other graphical content as may serve a particular implementation.

The communication interface 1210 can include hardware, software, or both. In any event, the communication interface 1210 can provide one or more interfaces for communication (such as, for example, packet-based communication) between the computing device 1200 and one or more other computing devices or networks. As an example, and not by way of limitation, the communication interface 1210 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 1210 may facilitate communications with various types of wired or wireless networks. The communication interface 1210 may also facilitate communications using various communication protocols. The communication infrastructure 1212 may also include hardware, software, or both that couples components of the computing device 1200 to each other. For example, the communication interface 1210 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
determining, by at least one processor, a request to utilize a large language model to generate an action plan via one or more software tools; and
in response to the request, generating, by the at least one processor, the action plan by traversing a decision tree comprising an action space involving the one or more software tools by iteratively:
selecting, utilizing a best-first search model, an action from a set of possible actions in the action space of the decision tree; and
expanding, utilizing the best-first search model, the action space of the decision tree to include an additional set of possible actions; and
executing, by the at least one processor, the action plan via one or more interactions with the one or more software tools according to the action.

2. The computer-implemented method of claim 1, wherein selecting the action comprises:
generating, via a plurality of prompts to the large language model, cumulative cost scores indicating costs of executing possible actions in the set of possible actions in the action space of the decision tree;
generating future cost scores for a set of future possible actions to complete the action plan; and
selecting the action from the set of possible actions in response to determining that the action has a lowest combined score based on a cumulative cost score of the action and a future cost score associated with the action.

3. The computer-implemented method of claim 2, wherein generating the cumulative cost scores comprises:
determining one or more cumulative cost scores of one or more ancestor actions of the action; and
summing the one or more cumulative cost scores of the one or more ancestor actions to generate a cumulative cost score for the action.

4. The computer-implemented method of claim 2, wherein generating the cumulative cost scores comprises:
generating, for the action, a self-consistency score of the large language model by determining a frequency of responses by the large language model indicating one or more actions including the action;
generating a heuristic plan score by comparing the action plan to successful action plan examples in a long-term memory associated with the large language model; and
generating a cumulative cost score of the action based on a combination of the self-consistency score and the heuristic plan score.

5. The computer-implemented method of claim 4, wherein generating the heuristic plan score comprises:
generating longest common sub-sequence scores between the action plan and the successful action plan examples in the long-term memory; and
selecting a longest common sub-sequence score with a highest value as the heuristic plan score.

6. The computer-implemented method of claim 4, wherein generating the self-consistency score comprises:
determining a subset of possible actions that are non-repeating for a subsequent step of the action plan, the subset of possible actions comprising the action; and
in response to a prompt executed in connection with the subset of possible actions to the large language model a plurality of times, determining frequencies of occurrence of possible actions of the subset of possible actions from responses generated by the large language model; and
generating the self-consistency score based on a frequency of occurrence of the action.

7. The computer-implemented method of claim 2, wherein generating the future cost scores comprises:
generating a heuristic action score by comparing the action to historical actions in successful action plan examples in a long-term memory associated with the large language model;
generating an imagination score indicating a proportion of one or more previously selected actions present of the action plan in a predicted action plan to reach a target for the request; and
generating a future cost score for the action based on a combination of the heuristic action score and the imagination score.

8. The computer-implemented method of claim 7, wherein generating the heuristic action score comprises generating the heuristic action score in response to determining, from the successful action plan examples in the long-term memory of the large language model, a historical action that is lexically closest to the action.

9. The computer-implemented method of claim 7, wherein generating the imagination score comprises:
executing a prompt to the large language model to generate a predicted action plan including one or more future possible actions to reach the target for the request; and
generating, for the action, the imagination score indicating a proportion of ancestor actions of the action in the predicted action plan.

10. The computer-implemented method of claim 1, wherein executing the action plan comprises providing one or more prompts to the large language model to perform a plurality of actions in the action plan by executing one or more application programming interface calls of the one or more software tools.

11. A system comprising:
one or more memory devices; and
one or more processors configured to cause the system to:
determine a request to utilize a large language model to generate an action plan via one or more software tools; and
in response to the request, generate the action plan by traversing a decision tree comprising an action space involving the one or more software tools by iteratively:
selecting, utilizing a best-first search model, an action from a set of possible actions to interact with the one or more software tools according to a cumulative cost score of the action and a future cost score of a set of future possible actions, the cumulative cost score generated from:
a self-consistency frequency score of the large language model for the action; and
a heuristic plan score based on a long-term memory associated with the large language model; and
expanding, utilizing the best-first search model, the action space of the decision tree to include an additional set of possible actions.

12. The system of claim 11, wherein the one or more processors are configured to cause the system to generate the self-consistency frequency score by determining a frequency of responses indicating one or more actions including the action by the large language model to a plurality of prompts.

13. The system of claim 11, wherein the one or more processors are configured to cause the system to generate the heuristic plan score by comparing a subsequence of actions of the action plan to subsequences of actions of successful action plan examples in the long-term memory of the large language model.

14. The system of claim 11, wherein the one or more processors are configured to cause the system to generate the future cost score by:
generating a heuristic action score based on a position of the action in the action plan relative to a lexically similar action in the long-term memory of the large language model;
generating an imagination score based on a ratio of one or more ancestor actions of the action in the action plan to actions to reach a target for the request in a predicted action plan; and
generating the future cost score based on a combination of the heuristic action score and the imagination score.

15. The system of claim 11, wherein the one or more processors are configured to cause the system to generate the action plan by:
determining, utilizing the best-first search model, a plurality of actions in the action space resulting in a lowest combined plan cost according to cumulative cost scores of the plurality of actions; and
providing, for display via a graphical user interface of a client device, the action plan including the plurality of actions and indications of corresponding application programming interface calls of the one or more software tools.

16. The system of claim 11, wherein the one or more processors are configured to cause the system to determine the long-term memory associated with the large language model by:
determining a successful action plan example in response to one or more user interactions indicating that a previous action plan generated is successful; and
adding the successful action plan example to the long-term memory.

17. A non-transitory computer readable medium comprising instructions that, when executed by a processing device, cause the processing device to perform operations comprising:
determining a request to utilize a large language model to generate an action plan via one or more software tools; and
in response to the request, generating the action plan by traversing a decision tree comprising an action space involving the one or more software tools by iteratively:
selecting, utilizing a best-first search model, an action from a set of possible actions to interact with the one or more software tools according to a cumulative cost score of the action and a future cost score of a set of future possible actions, the future cost score generated from:
a heuristic action score based on a long-term memory associated with the large language model; and
an imagination score corresponding to a predicted action plan generated by the large language model to reach a target for the request; and
expanding, utilizing the best-first search model, the action space of the decision tree to include an additional set of possible actions.

18. The non-transitory computer readable medium of claim 17, wherein selecting the action comprises generating the heuristic action score by:
determining average relative positions scores of historical actions in successful action plan examples in a long-term memory associated with the large language model; and
generating the heuristic action score utilizing an average relative position score of a historical action that is lexically closest to the action.

19. The non-transitory computer readable medium of claim 17, wherein selecting the action comprises generating the imagination score by:
causing the large language model to generate a predicted action plan to reach a target for the request;
determining a proportion of one or more previously selected actions of the action plan in the predicted action plan; and
generating the imagination score based on the proportion.

20. The non-transitory computer readable medium of claim 17, wherein selecting the action comprises generating the cumulative cost score of the action by:
generating a self-consistency score of the large language model indicating a frequency of responses by the large language model to a plurality of prompts based on the action;
generating a heuristic plan score based on a similarity of the action plan to a successful action plan example in the long-term memory; and
generating the cumulative cost score of the action by combining the self-consistency score and the heuristic plan score.
